(19) United States
(12) Patent Application Publication
(10) Pub. No.: US 2023/0299361 A1
(43) Pub. Date: Sep. 21, 2023

(54) ACYCLIC/CYCLIC ETHER BASED ELECTROLYTES OUTSTRETCHING THE LOW TEMPERATURE LIMIT OF SODIUM METAL ANODE

(71) Applicant: Trustees of Dartmouth College, Hanover, NH (US)

(72) Inventors: Chuanlong Wang, Hanover, NH (US); Weiyang LI, Hanover, NH (US)

(73) Assignee: Trustees of Dartmouth College, Hanover, NH (US)

(21) Appl. No.: 18/019,757

(22) PCT Filed: Aug. 13, 2021
(86) PCT No.: PCT/US2021/045949

§ 371 Date: Feb. 3, 2023

Related U.S. Application Data
(60) Provisional application No. 63/065,855, filed on Aug. 14, 2020.

(51) Int. Cl. H01M 10/0569; H01M 10/0568; H01M 10/054; H01M 4/38

(52) U.S. Cl. CPC H01M 10/0569; H01M 10/0568; H01M 10/054; H01M 4/381; H01M 2300/0037; H01M 2004/027

(57) ABSTRACT

In an embodiment, the present disclosure pertains to an electrolyte composition including a plurality of ether-based solvents and at least one sodium-based salt. The plurality of ether-based solvents include at least one acyclic ether and at least one cyclic ether. In a further embodiment, the present disclosure pertains to an energy storage device that includes an electrolyte composition of the present disclosure. In another embodiment, the present disclosure pertains to a method of making the electrolyte compositions of the present disclosure. Such methods generally include one or more of the following steps of mixing a plurality of ether-based solvents and at least one sodium-based salt, and forming the electrolyte composition.

### CROSS-REFERENCE TO RELATED APPLICATIONS

This application claims priority to U.S. Provisional Patent Application No. 63/065,855, filed on Aug. 14, 2020. The entirety of the aforementioned application is incorporated herein by reference.

### STATEMENT REGARDING FEDERALLY SPONSORED RESEARCH

This invention was made with government support under 80NSSC18K1514 awarded by the National Aeronautics and Space Administration (NASA). The government has certain rights in the invention.

### BACKGROUND

Lithium ion batteries suffer from severe energy and power losses when temperatures drop below 0° C. Moreover, the charge and mass migration is greatly hindered at low temperature owing to the increase of inactive lithium ions, leading to dendrite formation and propagation, and further performance failure. Various embodiments of the present disclosure seek to address the aforementioned limitations.

### SUMMARY

In an embodiment, the present disclosure pertains to an electrolyte composition. In some embodiments, the electrolyte composition includes a plurality of ether-based solvents and at least one sodium-based salt. In some embodiments, the plurality of ether-based solvents include at least one acyclic ether and at least one cyclic ether.

In a further embodiment, the present disclosure pertains to an energy storage device that includes the an electrolyte compositions of the present disclosure. In another embodiment, the present disclosure pertains to a method of making the electrolyte compositions of the present disclosure. In general, the method includes mixing a plurality of ether-based solvents and at least one sodium-based salt, and forming the electrolyte composition. In some embodiments, the method also includes associating the formed electrolyte composition with an energy storage device.

### DESCRIPTION OF THE DRAWINGS

FIG. 1A depicts an electrolyte composition according to an aspect of the present disclosure.

FIG. 1B depicts an electrode according to an aspect of the present disclosure.

FIG. 1C depicts an energy storage device according to an aspect of the present disclosure.

FIG. 1D depicts a method of forming an electrolyte composition according to an aspect of the present disclosure.

FIG. 2 illustrates low-temperature electrolyte design strategy and functions according to an aspect of the present disclosure. The designed low-temperature electrolytes composed of sodium conducting salts and unary/binary solvent include acyclic ethers and/or cyclic ethers in a range of mixing ratios. Such electrolytes could solve challenges occurred in batteries performing at low temperature, involving inhomogeneous electrolyte (e.g., frozen solvent and salt precipitation) and/or unstable solid electrolyte interphase (e.g., incompatible composition and porous morphology).

FIGS. 3A-3C illustrate low-temperature electrochemical behaviors at −20° C. FIG. 3A shows cycling performance of Na/Na symmetric cells operating at −20° C. in the eight 1M electrolyte candidates, at a current density of 0.5 mA cm⁻² with a capacity of 0.5 mAh cm⁻². FIG. 3B shows corresponding enlarged voltage profiles at the 50th cycle and the 100th cycle of four systems. FIG. 3C shows corresponding enlarged voltage profiles at the 50th cycle and the 100th cycle of the other four systems.

FIGS. 4A-4H illustrate low-temperature solid electrolyte interphase morphology at −20° C. Shown are scanning electron microscopy images of Na surface after 50 cycles (symmetric Na/Na cells) in the eight 1M electrolytes at a current density of 0.5 mA cm⁻² with a capacity of 0.5 mAh cm⁻². Insets are corresponding cross-section images.

FIGS. 5A-5H illustrate temperature-dependent solid electrolyte interphase composition evolution. X-ray photoelectron spectroscopy of Na surface after 50 cycles (symmetric Na/Na cells) in 1M sodium trifluoromethanesulfonate diethylene glycol dimethyl ether (NaOTf-DEGDME) electrolyte at a current density of 0.5 mA cm⁻² with a capacity of 0.5 mAh cm⁻² at temperatures of +20 ° C. and −20° C. is shown. High resolution C₁ₛ, O₁ₛ, S₂ₚ and F₁ₛ spectra are presented.

FIG. 6 illustrates lower-temperature electrochemical behaviors at −40° C. Long-term performance of Na/Na symmetric cells operating in 1M NaOTf-DEGDME electrolyte at rate current densities up to 1.0 mA cm⁻² with rate capacities up to 1.0 mAh cm⁻² at −40° C. is shown.

FIGS. 7A-7E illustrate extreme-cold condition investigation at −80° C. FIG. 7A shows photos of (1) 1M NaOTf-DEGDME, (2) 0.5M sodium trifluoromethanesulfonate diethylene glycol dimethyl ether/dioxolane (NaOTf-DEGDME/DOL) (5:5), and (3) 0.5M NaOTf-DEGDME/DOL (2:8) after storing at +20 ° C. and −80° C. for 24 hours. FIG. 7B shows temperature-dependent cycling of Na/Na symmetric cells in 0.5M NaOTf-DEGDME/DOL (5:5) and 0.5M NaOTf-DEGDME/DOL (2:8) at a current density of 0.2 mA cm⁻² along with a capacity of 0.1 mAh cm⁻². FIG. 7C shows temperature-dependent electrolyte resistance evolution of 1M NaOTf-DEGDME, 0.5M NaOTf-DEGDME/DOL (5:5) and 0.5M NaOTf-DEGDME/DOL (2:8). FIG. 7D shows differential scanning calorimetry thermograms on 1M NaOTf-DEGDME, 0.5M NaOTf-DEGDME/DOL (5:5) and 0.5M NaOTf-DEGDME/DOL (2:8) at low temperature down to −150° C. FIG. 7E shows long-term galvanostatic stripping/plating of Na/Na symmetric cells in 0.5M NaOTf-DEGDME/DOL (5:5) and 0.5M NaOTf-DEGDME/DOL (2:8) at a current density of 0.5 mA cm⁻² along with a capacity of 0.25 mAh cm⁻² and at a current density of 0.2 mA cm⁻² along with a capacity of 0.1 mAh cm⁻² at −80° C.

FIGS. 8A-8D illustrate electrochemical performance of Na/Na₃V₂(PO₄)₃ full cells using the 0.5M NaOTf-DEGDME/DOL (2:8) electrolyte at different low temperatures. FIG. 8A shows temperature-dependent galvanostatic cycling of cells at 0.2C (1C=110 mA g⁻¹, based on the active material of Na₃V₂(PO₄)₃) down to −60° C. with voltage cutoffs of 2.3 and 3.8 V. It should be noted that duration of cycling at each temperature was kept the same for comparison. FIG. 8B shows galvanostatic charge-discharge voltage profiles at 0.2C from 0° C. to −80° C. FIG. 8C shows long-term galvanostatic cycling of cells at 0.2C at −20° C., −40° C., and −60° C. FIG. 8D shows C-rate cycling performance (up to 1C) of cells at −40° C. and −60° C.

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that comprise more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

Lithium ion batteries (LIBs) have been extensively applied in portable electronics and electric vehicles because of their high energy and power density, and long cycle life at normal conditions. Nevertheless, they inevitably suffer from severe energy and power losses when temperatures drop below 0° C. Taking −40° C. as an example, a commercial 18650 LIB only delivers 5% of energy density and 1.25% of power density at this temperature, as compared to those achieved at room temperature (e.g., +20° C.). Such low temperatures badly effect the limits of commercial applications of LIBs in high-latitude country areas, such as Russia, Canada, and Greenland, especially during wintertime, when the outside temperature could be as low as −50° C.

In addition, the extreme cold environments in polar areas and in space make the operation of LIBs nearly impossible. For instance, the scientific investigation in the south polar zone faces a frigid −60° C. in winter and the Mars exploration encounters a gelid temperature as low as −125° C. At these temperatures, the lithium electrochemistry shows sluggish reaction activity, resulting in the reduction on energy and power. Moreover, the charge and mass migration is greatly hindered at low temperature owing to the increase of inactive lithium ions, leading to dendrite formation and propagation, and further performance failure.

In sum, a need exists for more effective electrolyte compositions for use in electrodes and energy storage devices (e.g., batteries) that can operate at low temperatures. Various embodiments of the present disclosure address the aforementioned need.

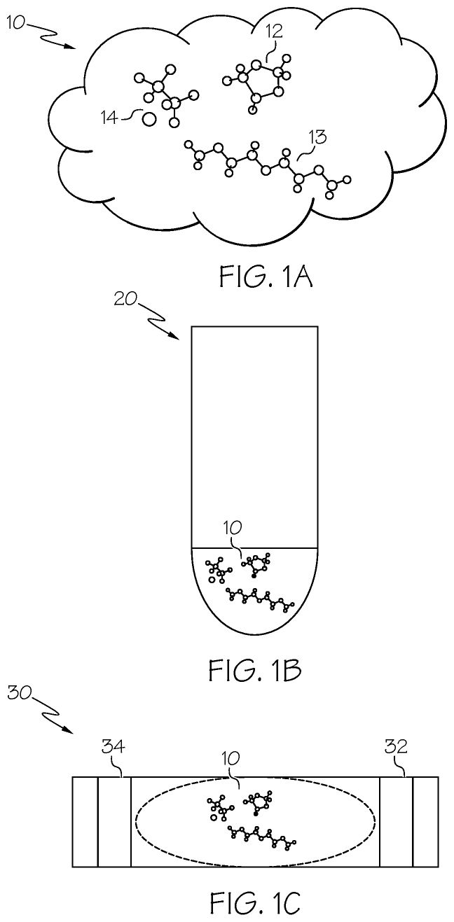

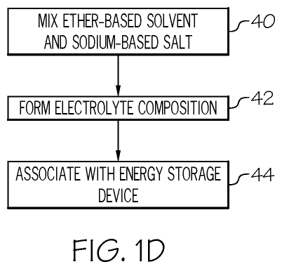

In some embodiments, the present disclosure pertains to electrolyte compositions that include at least one ether-based solvent and at least one sodium based salt. In some embodiments, the at least one ether-based solvent includes a plurality of ether-based solvents. In some embodiments, the plurality of ether-based solvents include at least one acyclic ether and at least one cyclic ether. In some embodiments illustrated in FIG. 1A, the electrolyte compositions are in the form of an electrolyte composition 10, which includes at least one cyclic ether-based solvent 12, at least one acyclic ether-based solvent 13, and at least one sodium-based salt 14.

In some embodiments, the present disclosure pertains to electrodes that include the electrolyte compositions of the present disclosure. In some embodiments illustrated in FIG. 1B, the electrodes can be in the form of electrode 20 having the electrolyte composition 10 associated with the electrode 20.

In some embodiments, the present disclosure pertains to energy storage devices that include the electrolyte compositions of the present disclosure. In some embodiments illustrated in FIG. 1C, the energy storage devices can be in the form energy storage device 30 having the electrolyte composition 10 as a component of the energy storage device 30. In some embodiments illustrated in FIG. 1C, the electrolyte composition 10 is associated with electrodes 32 and 34 within the energy storage device 30.

In some embodiments, the present disclosure pertains to methods of making the electrolyte compositions of the present disclosure. In some embodiments illustrated in FIG. 1D, the methods of making the electrolyte compositions of the present disclosure generally include one or more of the following steps of mixing at least one ether-based solvent and at least one sodium-based salt (step 40) and forming the electrolyte composition (step 42). In some embodiments, the method can be repeated until the desired amount of electrolyte composition is obtained. In some embodiments, the methods of the present disclosure also include a step of associating the electrolyte composition with an energy storage device (step 44).

As set forth in more detail herein, the electrolyte compositions of the present disclosure can have numerous embodiments. For instance, the electrolyte compositions of the present disclosure can include various ether-based solvents and sodium-based salts. In addition, the electrolyte compositions of the present disclosure can utilize variations of the ether-based solvents and sodium-based salts as disclosed herein. Additionally, the electrolyte compositions of the present disclosure can have numerous properties.

Furthermore, the electrolyte compositions of the present disclosure can be associated with various electrodes and energy storage devices. Moreover, various methods may be utilized to make the electrolyte compositions of the present disclosure.

### Electrolyte Compositions

As set forth in more detail herein, the electrolyte compositions of the present disclosure can include at least one ether-based solvent and at least one sodium-based salt. Additionally, the electrolyte compositions of the present disclosure can utilize variations of the at least one ether-based solvent and at least one sodium-based salt as disclosed herein. Moreover, the electrolyte compositions of the present disclosure can have various properties. In addition, the electrolyte compositions may have various applications and advantages.

### Ether-Based Solvents

The electrolyte compositions of the present disclosure can include various types of ether-based solvents. For instance, in some embodiments, the at least one ether-based solvent can include, without limitation, acyclic ethers, cyclic ethers, and combinations thereof.

In some embodiments, the at least one ether-based solvent include acyclic ethers. Acyclic ethers generally refer to ether-based solvents that are not in cyclical form. In some embodiments, the acyclic ethers can include, without limitation, 1,2-dimethoxyethane (DME), diethylene glycol dimethyl ether (DEGDME), diethyl ether, methyl ethyl ether, methyl-t-butyl ether, diphenyl ether, triethylene glycol dimethyl ether, tetraethylene glycol dimethyl ether and combinations thereof. In some embodiments, the acyclic ether is DME. In some embodiments, the acyclic ether is DEGDME. In some embodiments, the acyclic ether is a dual system including both DME and DEGDME in a wide range of mixing ratios.

In some embodiments, the at least one ether-based solvent include cyclic ethers. Cyclic ethers generally refer to ether-based solvents that are in cyclical form. In some embodiments, the cyclic ethers can include, without limitation, dioxolane (DOL), tetrahydrofuran (THF), ethylene oxide, tetrahydropyran, furanand, and combinations thereof. In some embodiments, the cyclic ether is DOL. In some embodiments, the cyclic ether is THF. In some embodiments, the cyclic ether is a dual system including both DOL and THF in a wide range of mixing ratios.

In some embodiments, the at least one ether-based solvent is a single ether-based solvent. In some embodiments, the at least one ether-based solvent is a plurality of ether-based solvents. In some embodiments, the at least one ether-based solvent is at least two ether-based solvents.

In some embodiments, the at least one ether-based solvent is at least one acyclic ether and at least one cyclic ether. In some embodiments, the at least one acyclic ether can include the acyclic ethers described herein. In some embodiments, the at least one acyclic ether can include, without limitation, DME, DEGDME, and combinations thereof.

In some embodiments, the at least one cyclic ether can include the cyclic ethers described herein. In some embodiments, the at least one cyclic ether can include, without limitation, DOL, THF, ethylene oxide, tetrahydropyran, furanand, and combinations thereof.

In some embodiments, the at least one acyclic ether is DEGDME and the at least one cyclic ether is DOL. In some embodiments, the at least one acyclic ether is DME and the at least one cyclic ether is DOL. In some embodiments, the at least one acyclic ether is DEGDME and the at least one cyclic ether is THF. In some embodiments, the at least one acyclic ether is DME and the at least one cyclic ether is THF.

In some embodiments, the at least one ether-based solvent is at least two ether-based solvents having various volume ratios. For instance, in some embodiments, the volume ratios are from about 9.9:0.1 to 0.1:9.9. In some embodiments, the volume ratios are from about 10:1 to 1:10. In some embodiments, the volume ratios are from about 9:2 to 2:9. In some embodiments, the volume ratios are from about 8:3 to 3:8. In some embodiments, the volume ratios are from about 7:4 to 4:7. In some embodiments, the volume ratios are from about 6:5 to 5:6. In some embodiments, the volume ratios are from about 5:4 to 4:5. In some embodiments, the volume ratios are from about 3:2 to 2:3. In some embodiments, the volume ratios are from about 2:1 to 1:2. In some embodiments, the volume ratio is 2:8. In some embodiments, the volume ratio is 1:1. In some embodiments, the volume ratio is 8:2.

In some embodiments, the volume ratio is 2:8. In some embodiments, the volume ratio is 5:5. In some embodiments, the volume ratio is 8:2. In some embodiments, the volume ratio can include, without limitation, an acyclic ether to a cyclic ether volume ratio (e.g., DME:DOL or DEGDME:DOL) or a cyclic ether to an acyclic ether volume ratio (DOL:DME or DOL:DEGDME).

In some embodiments, the at least one ether-based solvent of the present disclosure is utilized in a solvent system. For instance, the solvent system can include, without limitation, a unary system, a binary system, and combinations thereof.

In some embodiments, the solvent system is a unary system. In some embodiments, the unary system can include a single acyclic ether. In some embodiments, the single acyclic ether can include, without limitation, DME, DEGDME, pure DME, and pure DEGDME. For example, in some embodiments, the single acyclic ether is pure DME. In some embodiments, the single acyclic ether is pure DEGDME.

In some embodiments, the unary system can include a single cyclic ether. In some embodiments, the single cyclic ether can include, without limitation, DOL, THF, pure DOL, and pure THF. In some embodiments, the single cyclic ether is pure DOL. In some embodiments, the single cyclic ether is pure THF.

In some embodiments, the solvent system is a binary system. In some embodiments, the binary system can include, without limitation, a combination of acyclic ethers, a combination of cyclic ethers, and a combination of an acyclic ether and a cyclic ether. For example, in some embodiments, the binary system is a combination of an acyclic ether and a cyclic ether. In some embodiments, the binary system includes a mixed combination of DEGDME and DOL. In some embodiments, the binary system includes a mixed combination of DME and DOL. In some embodiments, the binary system includes a mixed combination of DEGDME and THF. In some embodiments, the binary system includes a mixed combination of DME and THF.

### Sodium-Based Salts

The electrolyte compositions of the present disclosure can include various types of sodium-based salts. For instance, in some embodiments, the at least one sodium-based salt can include, without limitation, sodium trifluoromethanesulfonate (NaOTf), sodium hexafluorophosphate (NaPF₆), sodium perchlorate (NaClO₄), sodium bis(trifluoromethanesulfonyl)imide (NaTFSI), sodium bis(fluorosulfonyl)imide (NaFSI), sodium tetrafluoroborate (NaBF₄), and combinations thereof.

In some embodiments, the at least one sodium-based salt is a single sodium-based salt. In some embodiments, the at least one sodium-based salt is a plurality of sodium-based salts. In some embodiments, the at least one sodium-based salt is at least two sodium-based salts.

In some embodiments, the at least one sodium-based salt of the present disclosure can be in a single phase or a mixed phase. For instance, in some embodiments, the at least one sodium-based salt is in a single phase. In some embodiments, the single phase includes a single phase of NaOTf, NaPF₆, NaClO₄, NaTFSI, or NaFSI. In some embodiments, the single phase is a single phase NaOTf. In some embodiments, the single phase is a single phase NaPF₆. In some embodiments, the single phase is a single phase NaClO₄.

In some embodiments, the at least one sodium-based salt can be in a mixed phase. For instance, in some embodiments, the mixed phase can be a mixed phase of two or more sodium-based salts including, but not limited to, NaOTf, NaPF₆, NaClO₄, NaTFSI, or NaFSI. In some embodiments, the mixed phase is a mixed phase of NaOTf and NaPF₆. In some embodiments, the mixed phase is a mixed phase of NaClO₄ and NaPF₆. In some embodiments, the mixed phase is a mixed phase of NaOTf and NaClO₄.

In some embodiments, the sodium-based salts in the electrolyte compositions of the present disclosure can include two sodium-based salts. In the some embodiments, the two sodium-based salts can be in a wide range of weight ratios. For example, in some embodiments, the weight ratios of the sodium-based salts are from about 9.9:0.1 to 0.1:9.9.

In some embodiments, the at least one sodium-based salts of the present disclosure can have various concentrations in the electrolyte compositions of the present disclosure. For instance, in some embodiments, the concentration is at least about 0.10 M. In some embodiments, the concentration is at least about 0.25 M. In some embodiments, the concentration is at least about 0.5 M. In some embodiments, the concentration is at least about 0.75 M. In some embodiments, the concentration is at least about 1 M. In some embodiments, the concentration is at least about 1.5 M. In some embodiments, the concentration is at least about 2.0 M.

In some embodiments, the concentration is in a range from about 0.1 M to about 2 M. In some embodiments, the concentration is in a range from about 0.2 M to about 1.9 M. In some embodiments, the concentration is in a range from about 0.3 M to about 1.8 M. In some embodiments, the concentration is in a range from about 0.4 M to about 1.7 M. In some embodiments, the concentration is in a range from about 0.5 M to about 1.6 M. In some embodiments, the concentration is in a range from about 0.6 M to about 1.5 M. In some embodiments, the concentration is in a range from about 0.7 M to about 1.4 M. In some embodiments, the concentration is in a range from about 0.8 M to about 1.3 M. In some embodiments, the concentration is in a range from about 0.9 M to about 1.2 M. In some embodiments, the concentration is in a range from about 1.0 M to about 1.1 M.

### Variations

The electrolyte compositions of the present disclosure can utilize variations of the at least one ether-based solvent and the at least one sodium-based salt as disclosed herein. For instance, in some embodiments, the electrolyte composition can be a unary solvent electrolyte, such as, for example, 1 M NaOTf salt in DEGDME solvent (1 M NaOTf-DEGDME). In some embodiments, the electrolyte composition can be a binary solvent electrolyte, such as, for example, 0.5 M NaOTf salt in a DEGDME/DOL solvent with a volume ratio of 2:8 (0.5 M NaOTf-DEGDME/DOL (2:8)). In some embodiments, the electrolyte composition can be a binary solvent electrolyte, such as, for example, 0.5 M NaOTf salt in a DEGDME/DOL solvent with a volume ratio of 5:5 (0.5 M NaOTf-DEGDME/DOL (5:5)). In some embodiments, the electrolyte composition can be a binary solvent electrolyte, such as, for example, 0.5 M NaPF₆ salt in a DME/DOL solvent with a volume ratio of 2:8 (0.5 M NaPF₆-DME/DOL (2:8)).

In some embodiments, the electrolyte composition can have at least 0.5 M of the at least one sodium-based salt, at least one cyclic ether, and at least one acyclic ether. In some embodiments, the electrolyte composition can have at least 0.5 M of the at least one sodium-based salt, and at least one cyclic ether. In some embodiments, the electrolyte composition can have at least 0.5 M of the at least one sodium-based salt, and at least one acyclic ether.

### Electrolyte Composition Properties

The electrolyte compositions of the present disclosure can have various properties. For instance, in some embodiments, the electrolyte compositions of the present disclosure are stable and homogeneous at low temperatures. For instance, in some embodiments, the electrolyte compositions are stable and homogeneous below −50° C. In some embodiments, the electrolyte compositions are stable and homogeneous below −75° C. In some embodiments, the electrolyte compositions are stable and homogeneous below −80° C. In some embodiments, the electrolyte compositions are stable and homogeneous below −150° C.

In some embodiments, the electrolyte compositions are operable below −40° C. In some embodiments, the electrolyte compositions are operable below −50° C. In some embodiments, the electrolyte compositions are operable below −75° C. In some embodiments, the electrolyte compositions are operable below −80° C. In some embodiments, the electrolyte compositions are operable below −150° C.

In some embodiments, the electrolyte compositions of the present disclosure maintain performance at low temperatures (e.g., the temperatures set out above). In some embodiments, the electrolyte compositions when associated with an electrode (e.g., Na metal) maintain good interphase morphology (e.g., smooth and uniform) at low temperatures. In some embodiments, the electrolyte compositions maintain stable thermal behavior over a wide range of low temperatures. In some embodiments, the electrolyte compositions of the present disclosure exhibit no salt precipitation at low temperatures. In some embodiments, the electrolyte compositions of the present disclosure have no solvent freezing issues at low temperatures.

In some embodiments, the electrolyte compositions have low electrolyte resistance and high ion transfer and migration at low temperatures. In some embodiments, the electrolyte compositions have no phase transition at low temperatures (e.g., frigid temperature down to −150° C.). In some embodiments, using the electrolyte compositions display very small overpotentials (e.g., <50 mV). In some embodiments, using the electrolyte compositions facilitate long-term cycling (e.g., over 2,000 hours).

In some embodiments, the electrolyte compositions of the present disclosure exhibit high capacity delivery, high capacity retention, high Coulombic efficiency and long cycle life when tested in full cell configuration at a low temperature (e.g., Na₃V₂(PO₄)₃ as cathode and sodium metal as anode in a full cell operating at −20° C.). In some embodiments, the electrolyte compositions display low dynamic viscosity. In some embodiments, the electrolyte compositions exhibit low electrolyte resistance.

### Energy Storage Devices

In some embodiments, the electrolyte compositions of the present disclosure may be associated with energy storage devices. As such, further embodiments of the present disclosure pertain to energy storage devices that include the electrolyte compositions of the present disclosure.

In some embodiments, the energy storages device can include, without limitation, batteries, capacitors, and combinations thereof. In some embodiments, the energy storage devices include batteries. In some embodiments, the batteries include, without limitation, sodium metal batteries, sodium ion batteries, sodium metal/ion batteries, lithium-based batteries, sodium-based batteries, lithium ion batteries, potassium-based batteries, titanium-based batteries, potassium ion based batteries, titanium-based potassium ion batteries, and combinations thereof.

In some embodiments, the batteries are sodium-based batteries. In some embodiments, the batteries are sodium metal batteries. In some embodiments, the batteries are lithium-based batteries. In some embodiments, the batteries are lithium-ion batteries.

### Electrodes

In some embodiments, the energy storage devices of the present disclosure may also include electrodes. In some embodiments, the electrolyte compositions of the present disclosure can be associated with an electrode. As such, further embodiments of the present disclosure pertain to electrodes that include the electrolyte compositions of the present disclosure.

The energy storage devices of the present disclosure may include various electrodes. For example, in some embodiments, the energy storage devices of the present disclosure may include a lithium-based electrode, a potassium-based electrode, a carbon-based electrode, a platinum-based electrode, a zinc-based electrode, and combinations thereof.

In some embodiments, the energy storage devices of the present disclosure may include an anode, a cathode, and combinations thereof. In some embodiments, the energy storage devices of the present disclosure include an anode. In some embodiments, the anode is a metal anode. In some embodiments, the anode is a sodium metal anode.

In some embodiments, the energy storage devices of the present disclosure include a cathode. In some embodiments, the cathode is a Na₃V₂(PO₄)₃ cathode.

### Methods of Making the Electrolyte Compositions

Additional embodiments of the present disclosure pertain to methods of making the electrolyte compositions of the present disclosure. Such methods generally include one or more of the following steps of: mixing at least one ether-based solvent and at least one sodium-based salt; and forming the electrolyte composition.

As discussed in further detail herein, various methods of mixing can be utilized in the formation of the electrolyte compositions of the present disclosure. For instance, in some embodiments, the mixing can include dissolving one or more sodium-based salts in one or more ether-based solvents. In some embodiments, the mixing occurs under an inert atmosphere. In some embodiments, the inert atmosphere can include, without limitation, an inert gas-filled environment. In some embodiments, the inert-gas filled environment is a glove box. In some embodiments, the inert gas can include, without limitation, helium, neon, argon, krypton, xenon, radon, and combinations thereof. In some embodiments, the inert atmosphere can be an argon-filled glove box (e.g., O₂<0.6 ppm, H₂O<0.1 ppm).

In some embodiments, the methods of the present disclosure also include a step of associating the formed electrolyte compositions of the present disclosure with an electrode, such as the electrodes of the present disclosure. In some embodiments, the methods of the present disclosure also include a step of associating the formed electrolyte compositions with an energy storage device, such as the energy storage devices of the present disclosure.

### Applications and Advantages

The present disclosure can have various applications and advantages. For instance, in some embodiments, the electrolyte compositions of the present disclosure work well at low temperatures, for example, down to or below −40° C. In contrast, current electrolyte compositions utilized in batteries suffer from automatically being shut down due to self-discharge at low temperatures.

As such, the electrolyte compositions of the present disclosure can have various applications in various environments. For instance, in some embodiments, the electrolyte compositions of the present disclosure can be utilized to protect portable electronic devices, such as, for example, phones, cameras, electric vehicles, and the like.

Due to their stability at low temperatures, the electrolyte compositions of the present disclosure can also be utilized in various environments and settings, such as aeronautics or space missions, polar expeditions, and in numerous military or civil facilities in cold regions. In more specific embodiments, the electrolyte compositions of the present disclosure can be applied for tools for scientific investigation in polar areas, as well as being applied to space exploration (e.g., Mars), where temperatures can drop as low as −125° C.

Additionally, the electrolyte compositions of the present disclosure can be utilized in various manners. For instance, in some embodiments, the electrolyte compositions of the present disclosure are utilized in electrodes. In some embodiments, the electrolyte compositions are utilized in energy storage devices (e.g., batteries).

### Additional Embodiments

Reference will now be made to more specific embodiments of the present disclosure and experimental results that provide support for such embodiments. However, Applicants note that the disclosure below is for illustrative purposes only and is not intended to limit the scope of the claimed subject matter in any way.

### Example 1.1. Acyclic/Cyclic Ether Based Electrolyte Outstretching the Low Temperature Limit of Sodium Metal Anode: Superiority Beyond −80° C.

This Example relates to acyclic/cyclic ether based electrolyte outstretching and the low temperature limit of sodium metal anode showing superiority beyond −80° C.

### Example 1.2. Introduction

Li-ion batteries (LIBs) have been extensively applied in portable electronics and electric vehicles because of their high energy/power density and long cycle life at normal conditions. Nevertheless, they inevitably suffer from severe energy and power losses when temperature drops below 0° C. Taking −40° C. as an example, a commercial 18650 LIB only delivers 5% of energy density and 1.25% of power density at this temperature, as compared to those achieved at room temperature (e.g., +20° C.). Such low temperature effect badly limits the commercial applications of LIBs in high-latitude country areas, such as Russia, Canada, and Greenland, especially during their wintertime, when the outside temperature could be as low as −50° C. In addition, the extreme cold environments in polar regions and outer space make the operation of LIBs nearly impossible. For instance, the scientific investigation in south polar zone faces a frigid −60° C. in winter and the Mars exploration encounters a gelid temperature as low as −125° C. At such temperature, the Li electrochemistry show sluggish reaction activity, resulting in the reduction on energy/power. What is more, the charge/mass migration is greatly hindered at low temperature owing to the increase of inactive Li ions, leading to dendrite formation/propagation and further performance failure.

Although adding ancillary device for heating or insulating could extend the use of Li electrochemistry at cold environment, the employment of additional components sacrifices the portability and increase energy/material cost. In light of this, searching for an alternative electrochemistry beyond Li technologies would be a promising approach, where Na stands out due to its similarity to Li but higher reactivity. The first ionization energy of Na is 495.8 kJ mol⁻¹, which is lower than that of Li (520.2 kJ mol⁻¹), leading to improved kinetics in chemical reactions. This increment in Na chemistry kinetics could offset the loss of reactivity due to low temperatures. Furthermore, pairing high-capacity cathode materials with metallic Na anode, such as oxygen (O₂) and sulfur (S), in Na metal batteries (NMBs) could enable multi-electron redox reactions, providing storage advantages over the direct replacement of Li with Na in Na ion batteries (NIBs). Thus, the investigation on electrochemical behavior of Na metal at low temperature is one of the factors to develop such battery chemistry.

Up to now, few studies on low temperature chemistry or performance of Na metal have been reported. In 2016, one group compared Na metal stripping/plating efficiency and revealed Na morphology at 0° C. and +25° C. in ionic liquid. Nonetheless, neither long-term stability nor beyond sub-ambient temperature investigation was detailed in the study. To engineer ultralong stable Na metal working at low temperature, fundamental understandings on its electrochemistry are critical. In general, the Na performance at low temperature is determined by two factors, including the resistance of electrolyte and stability of solid electrolyte interface (SEI). Firstly, the resistance of electrolyte solutions increases rapidly with the decrease of temperature owing to relatively high freezing points of traditional carbonate solvents and limited solubility of conducting salts. For instance, ethylene carbonate (EC) and dimethyl carbonate (DMC) have high freezing points of +35° C. and +3° C., respectively Secondly, even though using the same electrolyte, the SEI compositions and morphology at low temperature are different from those at ambient temperature due to the change of highest occupied molecular orbital (HOMO)-lowest unoccupied molecular orbital (LUMO) energies.

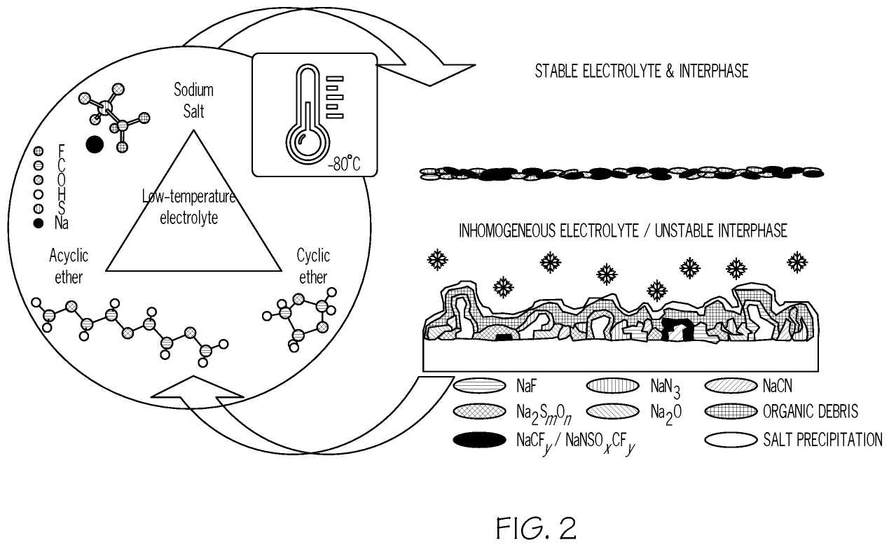

To address some of the above challenges, Applicant employed a method to provide effective low-temperature electrolytes. Specifically, Applicant tamed acyclic ethers with/without cyclic ethers as solvent on account of their much lower melting points and more compatibility to Na metal on SEI chemistry, compared to those of carbonate counterparts. Various widely used Na salts were screened in the combination with unary and/or binary solvent systems to evaluate electrolyte homogeneity as well as Na stability at low temperature. Applicant's findings reveal that an electrolyte having sodium trifluoromethanesulfonate (NaOTf) salt and unary solvent of diethylene glycol dimethyl ether (DEGDME) shows superior stability on Na metal down to −40° C. Further introduction of dioxolane (DOL) in forming binary solvent at an optimal ratio could effectively outstretch the stable working temperature all the way down to −80° C. Such superiority is ascribed to the following two merits: i) the combination of NaOTf and acyclic ether of DEGDME leads to uniform and compatible SEI formation; and ii) cyclic ether of DOL is a reconcilable anti-freezer and diluent, which could drop down phase transition temperature and lower electrolyte viscosity, respectively. The challenges and Applicant's strategy on the design of low temperature electrolyte have been illustrated in FIG. 2.

Taking advantage of the design, Applicant first demonstrated that the unary solvent electrolyte composed of NaOTf and DEGDME could stabilize Na/Na symmetric cycling at a high current density up to 1 mA cm⁻² along with a capacity up to 1 mAh cm⁻² at a temperature as low as −40° C. What is more, the binary solvent electrolyte containing NaOTf and DEGDME/DOL (in a volume ratio of 2:8) could enable stable Na plating/striping with a low overpotential of 50 mV even at gelid −80° C. for over 2,000 hours. Pairing phosphate Na₃V₂(PO₄)₃ cathode and Na anode in such electrolytes further demonstrates the feasibility of low temperature full cell applications. In addition, Applicant provided evidence showing that the designed electrolytes could maintain stability without phase transition even down to −150° C. Last but not least, Applicant's demonstrate that the binary solvent strategy could be applied to other systems based on different salts, such as NaPF₆-based electrolytes. This indicates the promising role of such electrolytes in the further energy storage application operating at extreme cold conditions.

### Example. 1.3. Domestication on Low Temperature Electrolytes

As a highly compatible electrolyte used for metallic Na at ambient temperature, 1M sodium hexafluorophosphate (NaPF₆) in DEGDME was first evaluated by electrochemical impedance spectroscopy (EIS). Both reversible electrodes (symmetric Na/Na) and blocking electrodes (symmetric stainless steel/stainless steel) were employed for the evaluation. The Nyquist plot at low temperature of −20° C. shows a much higher interfacial impedance, 18 times higher than that at +20° C. Such high impedance largely hinders Na⁺ electromigration and increases polarization, which harms battery performance. Further exploring the mechanism of impedance increase, Applicant found that the electrolyte resistance escalated dramatically with the decrease of temperature, especially below −20° C. Moreover, the enlargement of resistance is mainly caused by the precipitation of NaPF₆ due to the decrease of salt solubility. The impractical use of 1M NaPF₆-DEGDME at low temperature leads to the screening of salt-solvent combination.

Low melting point (mp) ethers, including DEGDME (mp=−64° C.), 1,2-dimethoxyethane (DME, mp=−58° C.) and 1,3-dioxolane (DOL, mp=−95° C.) were chosen as candidate solvents. Among all three ethers, cyclic DOL not only has the lowest mp, but possess low dynamic viscosity value at low temperature. In addition to NaPF₆, other candidate salts including NaOTf, sodium perchlorate (NaClO₄), sodium bis(trifluoromethanesulfonyl)imide (NaTFSI) and sodium bis(fluorosulfonyl)imide (NaFSI) were combinatorially mingled with all three solvents. The concentration of salt in solvent was kept as 1M for the screening on the uniformity of unary solvent electrolytes at low temperature.

The screening results reveal that NaPF₆ could not uniformly dissolve in 1M concentration in three solvents while the other four salts present good dissolution in DEGDME at low temperature. In contrast, DOL cannot easily solvate Na salts except for NaTFSI. Such observations are in well consistence with the fact that DEGDME has a higher dielectric constant value (7.30) than that (7.00) of DOL. In sum, eight out of fifteen electrolytes are thermodynamically stable at low temperature (−35° C.) in 1M concentration in unary solvent systems, which are subjected to further electrochemical stability evaluation on metallic Na.

### Example. 1.4. Behavior Comparison on Unary Solvent Electrolytes at Room Temperature and Low Temperature

Galvanostatic cycling measurements were performed in symmetric Na/Na cells (2032 type coin cells) for repeated stripping and plating at low temperature of −20° C. and at room temperature of +20° C. (as control group). All the eight 1M electrolytes were subjected to a current density of 0.5 mA cm⁻² with a cycling capacity of 0.5 mAh cm². At +20° C., 1M NaOTf-DEGDME presents the most stable cycling and smallest average overpotential of less than 10 mV for 600 hours (300 cycles). In contrast, 1M NaTFSI-DOL shows a great enlargement trend, which speedily reaches to a high overpotential of 1V. What is worse, 1M NaTFSI-DEGDME and NaTFSI-DME result in early failure of reaching voltage protection (5V) at 32 hours (16 cycles) and at 44 hours (22 cycles), respectively. The rest of electrolytes exhibit asymmetric voltage profiles over cycling, indicating the parasitic reactions between electrolytes and Na. The overpotential and plateaus symmetricity were compared in the enlarged voltage profiles at the 50th cycle (100 hours). The metallic Na performance (overpotential and cycling) in the eight electrolytes is in a trend of decreasing as follows: NaOTf-DEGDME>NaFSI-DME≥NaFSI-DEGDME>NaClO₄-DME>NaClO₄-DEGDME>NaTFSI-DOL>NaTFSI-DEGDME (early failure)>NaTFSI-DME (early failure).

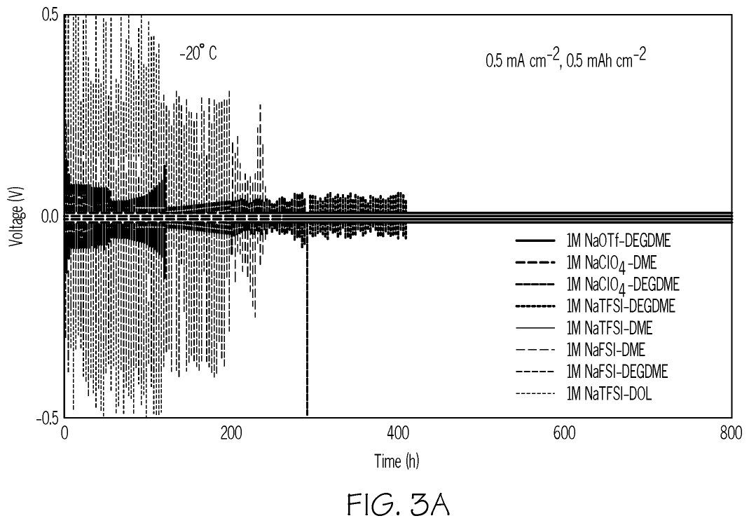

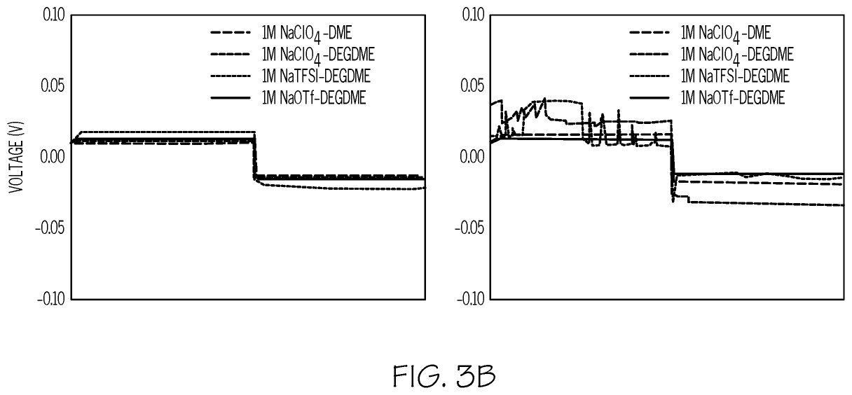

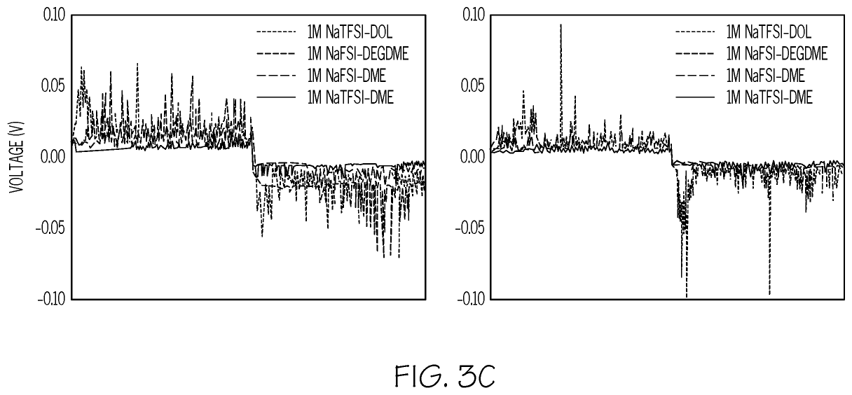

Nonetheless, different electrochemical behaviors were observed at −20° C. (FIG. 3A). Specifically, compared to the control groups (+20° C.), all the eight systems exhibit longer-term performance without early reaching voltage limit at low temperature. Such difference is possibly because of the reduced reactivities of Na metal and electrolytes at lower temperature. Among all electrolytes, 1M NaOTf-DEGDME displays highest stability with a lowest overpotential of 16 mV. The smooth and steady voltage plateaus are detailed in its enlarged voltage profile from the 50th to the 100th cycle (FIG. 3B). In contrast, non-symmetric and fluctuating (voltage spikes) behaviors are observed for NaTFSI-DOL, NaFSI-DEGDME, NaFSI-DME and NaTFSI-DME starting from the 50th cycle (FIG. 3C). In short, at −20° C., the metallic Na performance (overpotential and cycling) in the same electrolytes is in a trend of decreasing as follows: NaOTf-DEGDME>NaClO₄-DME>NaClO₄-DEGDME>NaTFSI-DEGDME>NaTFSI-DME>NaFSI-DME>NaFSI-DEGDME>NaTFSI-DOL.

It is clear that two different trends observed in electrochemical behaviors are dependent on testing temperature (+20° C. vs. −20° C.). There are five systems, including 1M NaOTf-DEGDME, NaClO₄-DME, NaFSI-DME, NaTFSI-DEGDME and NaTFSI-DOL, showing four representative behavior patterns. Firstly, 1M NaOTf-DEGDME exhibits good performance (low overpotential without obvious spikes) at both +20° C. and −20° C. Secondly, 1M NaClO₄-DME and NaTFSI-DEGDME perform better at −20° C. than at +20° C. Surprisingly, NaTFSI-DEGDME not only prevents early failure, but shows no obvious spikes at −20° C., compared to the case at −20° C. Thirdly, 1M NaFSI-DME works worse at −20° C. than at +20° C., where high overpotential and large spikes are observed at lower temperature. Fourthly, 1M NaTFSI-DOL unveils poor performance at both +20° C. and −20° C.

### Example. 1.5. Characterizations on Unary Solvent Electrolytes at Room Temperature and Low Temperature

Since the overpotential and voltage spikes are largely dependent on the SEI status, both morphology and chemistry of such interphases were characterized through scanning electron microscopy (SEM) and X-ray photoelectron spectroscopy (XPS), respectively.

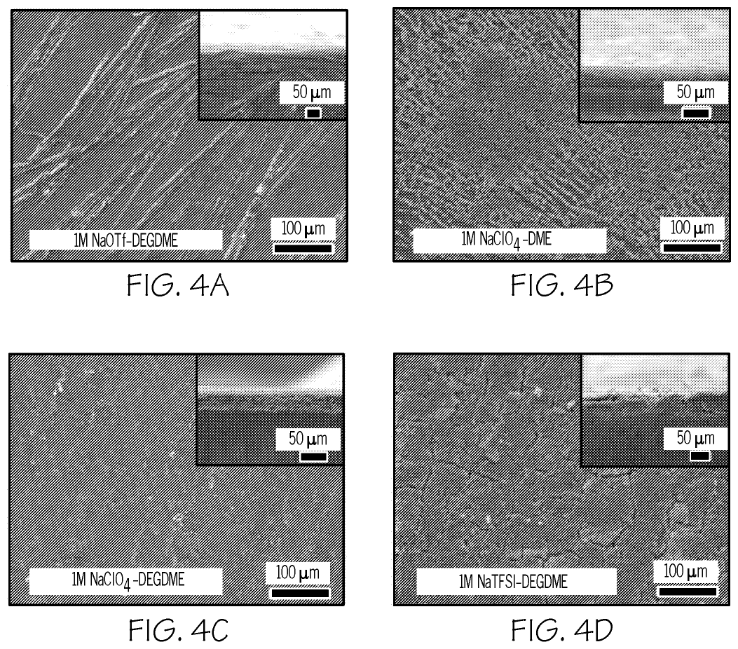

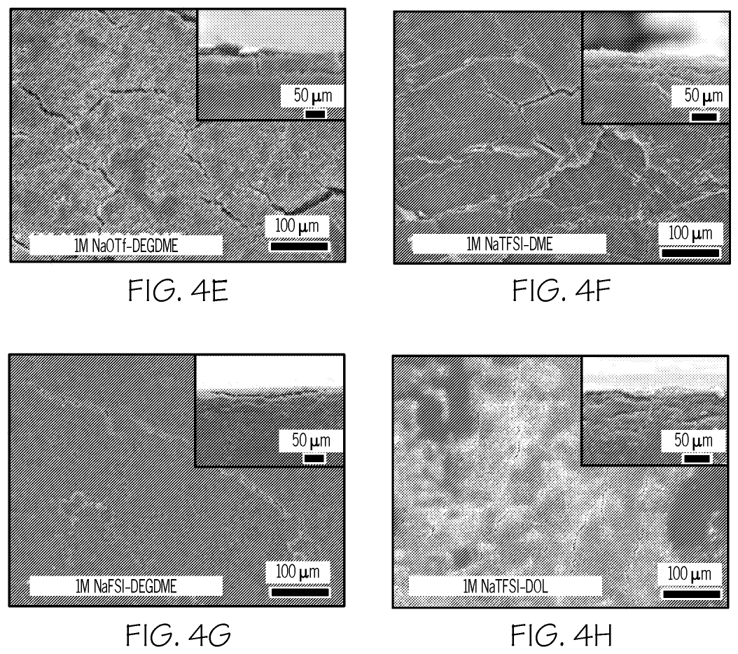

The SEM images of Na surface/cross-section after cycling at 0.5 mA cm⁻² along with 0.5 mAh cm⁻² at −20° C. are revealed in FIGS. 4A-4H. 1M NaOTf-DEGDME displays smooth surface at both temperatures, where leaf-vein texture could be observed on the surface and within the cross-section. Such unique SEI layers are thin, compact and protective, the formation of which could block further contact between electrolyte and Na substrate without introduction of huge polarization. The good and consistent SEI morphology at both +20° C. and −20° C. corresponds well with the superior electrochemical performance at both temperatures. As to 1M NaClO⁴-DME systems, the surfaces show contrasting conditions at different temperatures. A relatively smooth surface with spindle-shaped clusters is observed for −20° C. sample while a broken and detached SEI layer is revealed at +20° C. This destroyed SEI is well consistent with the worse behavior at +20° C., showing higher overpotential and large voltage spikes. It seems that lower temperature helps to stabilize the SEI formation in this electrolyte system, leading to stable Na stripping/plating.

Notwithstanding, corrosive and unsmooth Na surfaces are unveiled in 1M NaFSI-DME at both +20° C. and −20° C. At −20° C., deep cracks are disclosed, indicating low mechanical property of the SEI layer. Such destroyed surface expose fresh Na substrate to electrolyte for continuous reactions. In comparison, no cracks but a number of pores are detected at +20° C. sample. These pores are possibly due to the strong SO₂ gas evolution through the breakage of F(SO₂)₂N (decomposition product of FSI⁻) under strong attraction of oxygen (O) atoms to the metal surface at higher temperature. Similar fractured and porous interphases are also observed when using NaTFSI as salt. In NaTFSI based electrolytes, the degree of fragmentation decreases significantly with the drop of temperature. For instance, at +20° C., 1M NaTFSI-DEGDME system fails at the 16th cycle and already presents badly damaged interphase. Contrarily, at −20° C., only a mildly damaged surface is revealed after 50 cycles. The above phenomena correspond well with previous reports that NaTFSI and NaFSI salts could cause plenty of side reactions with metallic Na even though LiTFSi is frequently used salt for Li metal.

Besides salt effect, solvents also contribute to surface morphology evolution. At ambient temperature, cyclic DOL is more liable on gas formation than acyclic DME/DEGDME because of the distinct HOMO-LUMO energies of the complex of Na⁺ ion and solvent. Such difference is one of the reasons that larger pores and thicker SEI are observed using NaTFSI-DOL compared to NaFSI-DME at +20° C. However, such gas-evolving reaction can be effectively suppressed at −20° C., where no pores are revealed (FIGS. 4A-4H). On the other hand, DME has a similar LUMO energy compared to that of DEGDME, indicating that salt effect dominates the SEI evolution when using acyclic ethers as solvent.

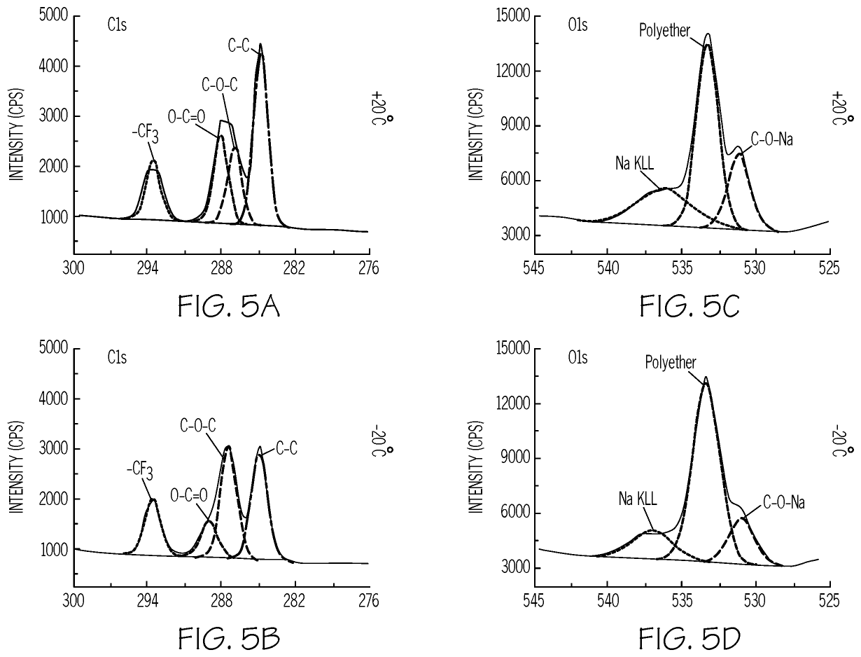

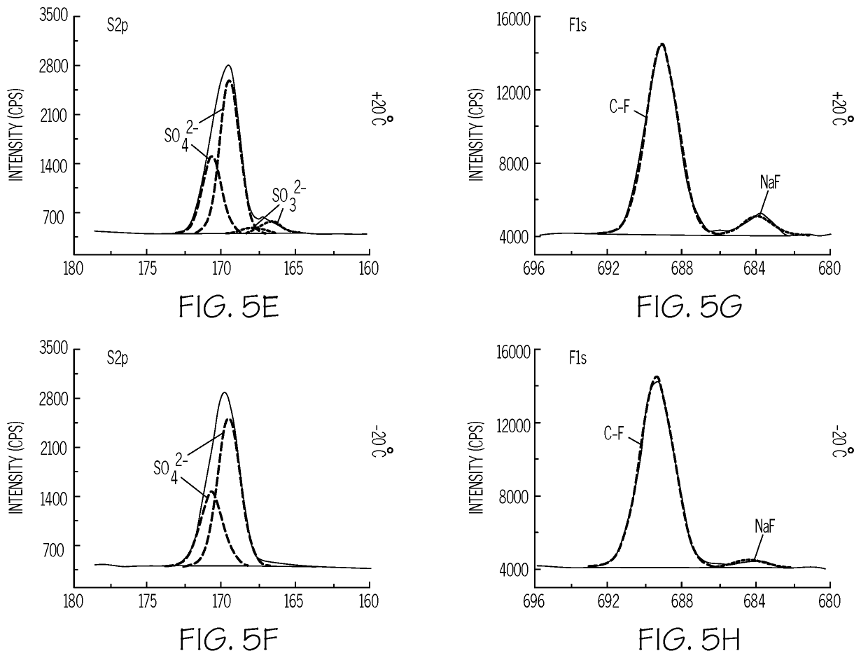

Other than morphology, the chemistry of SEI is another crucial factor determining electrochemical performance of Na. The binding energies of all elements were calibrated with respect to Cis at 284.8 eV in XPS profiles. The spectra of C₁ₛ, O₁ₛ, S₂ₚ and F₁ₛ in 1M NaOTf-DEGDME at +20° C. and −20° C. are shown in FIGS. 5A-5H. In C₁ₛ profile, binding energy at 293.4 eV is assigned to —CF₃ while the ones at 288.7 eV and 286.6 eV are ascribed to O—C═O and C—O—C. As to O₁ₛ, 533.3 eV and 531.2 eV correspond to polyether and C—O—Na (e.g., RCH₂ONa), respectively, while 536.3 eV is attributed to Na KLL. Regarding F₁ₛ, the energies of 689.2 eV and 684.1 eV are assigned to C—F and NaF. Two doublets S₂ₚ peaks at 169.6 eV and 167.2 eV (based on the 2p_{3/2}), respectively, are attributed to SO₄^{2—} and SO₃²⁻. The surface chemistry comparison at +20° C. and −20° C. reveals that SEI compositions are very similar, both of which are composed of NaCF₃, Na₂SO₄, NaF, C—O—Na and organic debris. At −20° C., Na₂SO₃ is absent on the SEI surface but presents at inner layer. In contrast, Na₂S (161.1 eV) is detected as one of inner layer components at +20° C. The presence of less reduced product at −20° C. suggests that the reaction kinetics between the electrolyte and Na is thermodynamically limited at lower temperature.

In comparison, the SEI compositions are greatly distinct at +20° C. and −20° C. for 1M NaClO₄-DME. In Cl₂ₚ spectrum, Cl⁻ (198.4 eV, based on 2p_{3/2}) is detected in +20° C. sample all the way to depth of 15 nm. In contrast, for −20° C. sample, ClO₄⁻ (208.5 eV, based on 2p_{3/2}) and ClO₃⁻ (206.3 eV, based on 2p_{3/2}) are observed on the surface along with ClO₂⁻ (203.8 eV) identified at the inner zone. Such difference indicates that lower temperature could alleviate severe corrosion, where fully reduced NaCl is generated from highly oxidative Cl (+7) in NaClO₄. At −20° C., partial reduction to NaClO₃ (+5)/NaClO₂ (+3) could result in much more uniform and smoother SEI (FIGS. 4A-4H).

As to 1M NaFSI-DME, samples at +20° C. and −20° C. exhibit alike SEI components. At the surface, F-SO₂ (170.2 eV, based on 2p_{3/2}) along with S—F (687.8 eV) and N—S (399.3 eV) indicates the presence of NaNSO₂F while S₂O₃²⁻ (168.7 eV, based on 2p_{3/2}) supports the existence of Na₂S₂O₃. At +20° C., Na₂S is a component appearing at inner layer. In contrast, the SEI composition at −20° C. is more complicated. In addition to the above ingredients, Na₂SO₃ is detected on the surface while both NaN₃ (403.6 eV, 1N; 398.5 eV, 2N) and Na₂O (528.2 eV) are revealed in the bulk. Surprisingly, different from the cases of NaOTf-DEGDME and NaClO₄− DME, lower temperature does not ‘cool down’ the reactions between NaFSI-DME and Na. Instead, the coldness preferentially triggers more completed FSI⁻ decomposition, leading to complex SEI evolution and further resulting in cracked SEI morphology.

Similarly, 1M NaTFSI-DEGDME also divulge analogous SEI chemistry at +20° C. and −20° C. Due to comparatively different anion structure of TFSI⁻, the SEI species are moderately distinctive compared to those using FSI⁻. The identification of —CF₂ (292.3 eV) and C—SO₂ (287.2 eV) disclose the presence of NaSO₂CF₂ in addition to Na₂SO₃, Na₂S, NaF and NaCN (397.4 eV). Since most of these compounds present at all depth of SEI layer, it suggests that the layers cannot effectively protect the intense reactions. Unexpectedly, the replacement of DEGDME using DOL in NaTFSI-DOL could, to some extent, suppress the decomposition of TFSI⁻, which is supported by the identification of N—S and CFₓ—SO₂ (168.9 eV), suggesting the presence of NaNSO₂CFₓ(x=2 or 3). Such inhibition effect is more effective at lower temperature since the −20° C. sample exhibits simpler compositions and thinner layer compared to those at +20° C.

Based on electrochemical performance and SEI morphology and chemistry, both NaFSI and NaTFSI based electrolytes are excluded for lower temperature evaluation due to their destructive reactions. In contrast, NaOTf-DEGDME electrolyte stands out as the best system and is subjected to lower temperature investigation.

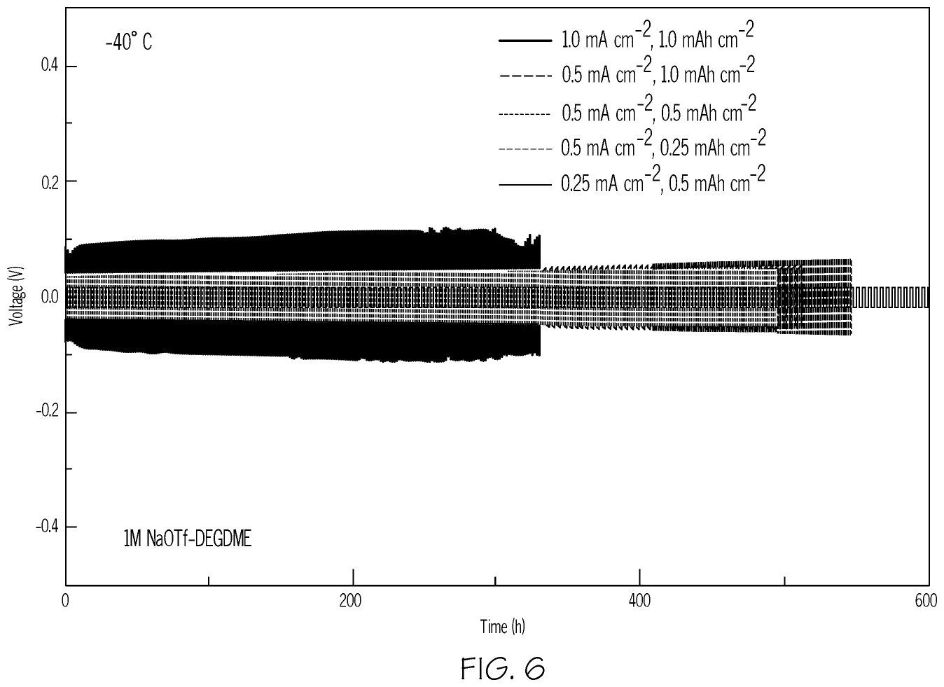

When further decreasing temperature to a lower value of −40° C., 1M NaOTf-DEGDME could still maintain high Na cycling stability over a rate current density up to 1 mA cm⁻² along with a rate capacity up to 1 mAh cm⁻² (FIG. 6). At a current density of 0.25 mA cm⁻² (0.5 mAh cm⁻²), a low overpotential of 16 mV can be maintained for over 600 hours operation. At a higher current density of 0.5 mA cm⁻² (1 mAh cm⁻²), the overpotential initially starts as 40 mV and marginally rises to 50 mV after 500 hours, that is less than 0.2% increment per cycle. Even at a four-time high density of 1 mA cm⁻² (1 mAh cm²), an average overpotential of 100 mV can sustain for over 300 hours.

### Example. 1.6. Behavior Comparison on Binary Solvent Electrolytes at Room Temperature and Low Temperature

The high viscosity of acyclic ethers (DEGDME/DME) potentially harm electrolyte resistance, especially at cold conditions. In comparison, the cyclic ether of DOL has a much lower viscosity value. In this case, introducing DOL into DEGDME/DME as binary solvent system could be beneficial for the electrolyte working at extreme low temperatures. However, salt dissolving/Na⁺ solvation ability of DOL is lower than that of DEGDME/DME because DOL is a non-polar solvent while DEGDME and DME are polar aprotic solvents. That being said, the optimal balance between DEGDME/DME and DOL is pivotal, where three volume mixing ratios of 2:8, 5:5 and 8:2 (DEGDME/DME to DOL) are evaluated. The concentration of salt in solvent is adjusted (1M or 0.5M) for binary solvent electrolytes based on screening results of unary solvent ones. The prepared systems are then subjected to thermodynamic stability evaluation at low temperature, the process of which is same to that conducted for unary solvent systems. For 1M NaOTf based systems, NaOTf-DEGDME/DOL (2:8) shows precipitation at low temperature. With a smaller concentration of 0.5M, NaOTf can maintain dissolved in both DEGDME/DOL and DME/DOL in all three mixing ratios. Such phenomena suggest the importance of both solvent mixing ratio and salt concentration on the homogeneity of binary solvent electrolytes at low temperature. Besides NaOTf, other two salts including NaClO₄ and NaPF₆ are also investigated in 0.5M concentration as control group.

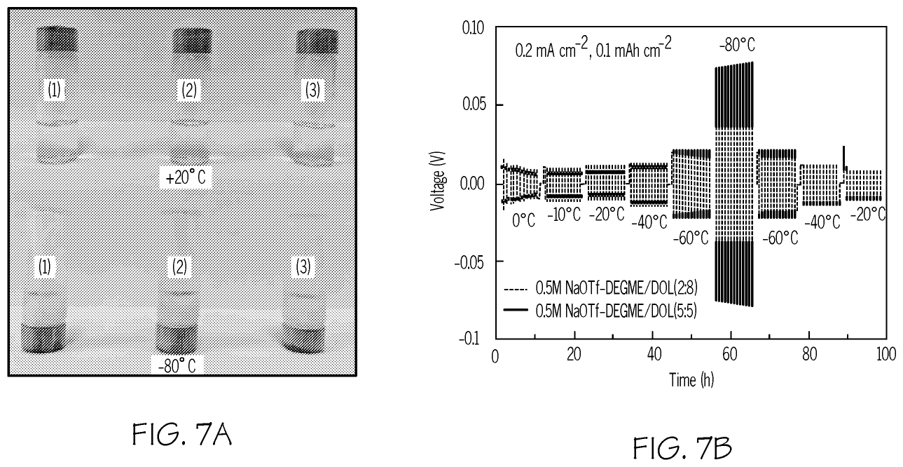

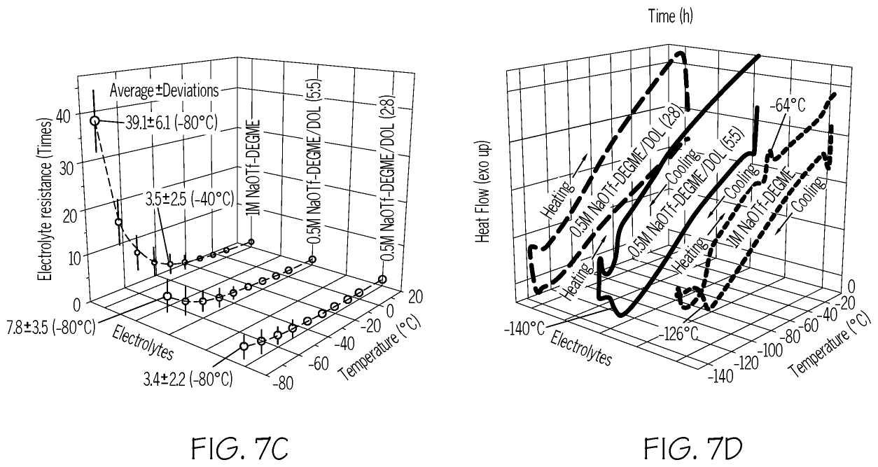

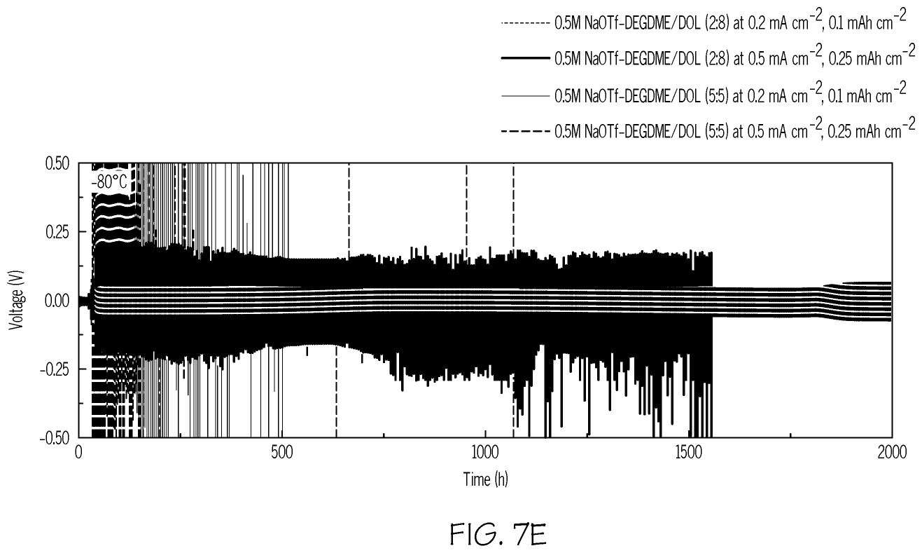

After screening, temperature-dependent cycling in Na/Na symmetric cells is performed on the candidate binary solvent electrolytes. 1M NaOTf-DEGDME/DOL (8:2 and 5:5) can perform well at a temperature as low as −60° C., but not well at −80° C., where a higher content of DOL leads to better stability. Nevertheless, a lower NaOTf concentration of 0.5M in DEGDME/DOL effectively improve the performance at −80° C. (FIG. 7). At such concentration level, a higher proportion of DOL could dramatically decrease overpotential from 75 mV (DEGDME/DOL in 5:5) to 35 mV (DEGDME/DOL in 2:8) at −80° C. (FIG. 7B). Nonetheless, the stable low temperature performance is only observed for DEGDME/DOL binary systems instead of DME/DOL ones.

Further investigation on the stability improving mechanism, Applicant found that the electrolyte resistance of 0.5M NaOTf-DEGDME/DOL (2:8) at −80° C. is only 3.4 times higher than that at +20° C. (FIG. 7C). This resistance increment is less than half of the one of 0.5M NaOTf-DEGDME/DOL (5:5) and is ten times smaller than the one of 1M NaOTf-DEGDME.

Correspondingly, 0.5M NaOTf-DEGDME/DOL (2:8) shows the slowest ionic conductivity drop across temperatures among all studied systems. The lower dynamic viscosity of DEGDME/DOL (2:8) binary solvent is one of the main reasons for such small electrolyte resistance change and/or slow ionic conductivity drop at low temperatures. Since no obvious phase transition (e.g., frozen solvent and/or salt precipitation) was visually detected at −80° C. (FIG. 7A), differential scanning calorimetry (DSC) was conducted to investigate thermal behavior to an outer space temperature of −150° C. (FIG. 7D). The DSC profiles confirm that no phase transition presents for three systems above/at −80° C. However, 1M NaOTf-DEGDME displays a second-order phase transition at −126° C. during cooling while a first-order phase transition at −64° C. (the mp of DEGDME) during subsequent heating. As to 0.5M NaOTf-DEGDME/DOL (5:5), phase transition is not detected until at −140° C. Superiorly, 0.5M NaOTf-DEGDME/DOL (2:8) shows no phase transition all the way down to −150° C.

Coulombic efficiency (CE) behavior of Na metal/copper (Cu) foil cells in the binary solvent system of 0.5M NaOTf-DEGDME-DOL (2:8) was demonstrated in comparison to that in the unary solvent system of 1M NaOTf-DEGDME. The binary solvent system presents a stable stripping/plating profile and high efficiency. The difference could be ascribed to the uniform and robust SEI formation in the binary solvent system.

Taking advantages of the low resistance and good thermal behavior, long-term Na/Na symmetric cells cycling in 0.5M NaOTf-DEGDME/DOL (2:8) at −80° C. was demonstrate in FIG. 7E. The electrolyte could stabilize Na performance, displaying a small average overpotential of 50 mV without enlarging trend for over 2,000 hours at 0.2 mA cm⁻² along with 0.1 mAh cm⁻². Even at a harsher current/capacity condition (0.5 mA cm⁻² along with 0.25 mAh cm⁻²), a stable 1,000-hours operation can still be achieved. In comparison, 0.5M NaOTf-DEGDME/DOL (5:5) system exhibits a growing overpotential trend with a fluctuating voltage behavior at −80° C.

On top of the improvements in electrolyte properties, the binary-solvent system can alter the features of the SEI in comparison to the unary-solvent one. Specifically, the gradual increase of the volume fraction of DOL results in the vanishing of leaf-vein-like texture that was observed in NaOTf-DEGDME at low temperatures. As to the composition, XPS profiles of the NaOTf-DEGDME/DOL electrolyte at −80° C. suggest similar SEI components detected in its unary-solvent counterpart. The uniformity/homogeneity of SEI achieved at −80° C. using the binary-solvent electrolyte supports the long-term stability observed in Na/Na symmetric cells (FIG. 7E).

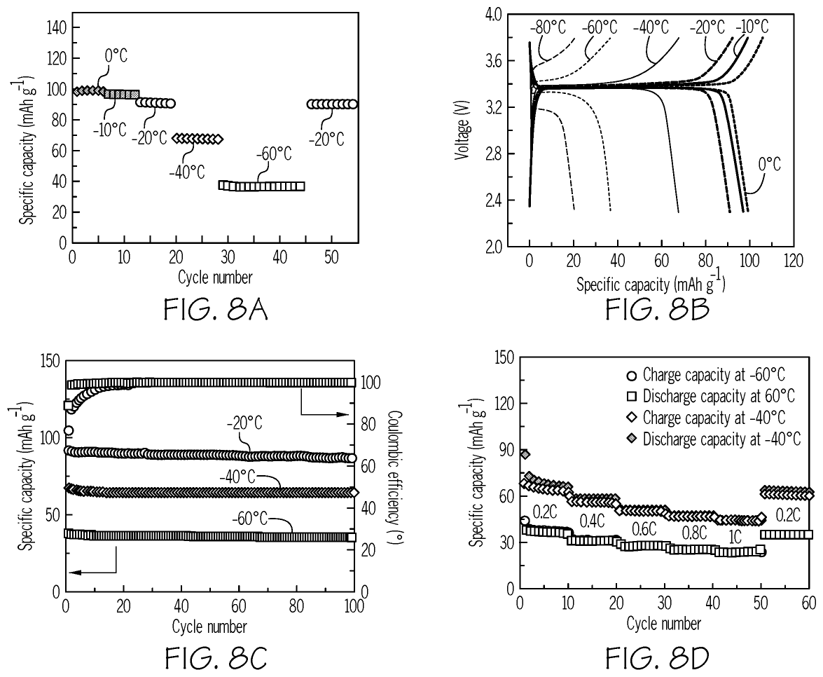

Full cells having Na₃V₂(PO₄)₃ as the cathode and Na metal as the anode in the 0.5M NaOTf-DEGDME/DOL (2:8) electrolyte were demonstrated at 0.2C (1C=110 mA g⁻¹) at low temperatures down to −80° C. (FIG. 8). Galvanostatic cycling (FIG. 8A) reveals that the discharge capacity decreases with the cell being sequentially cooled. At −60° C., ˜42% of the specific capacity obtained at −20° C. can be retained. The capacity loss from the temperature stepping is reversible, which is fully recovered as the temperature rises. The charge-discharge voltage profiles from 0° C. to −80° C. (FIG. 8B) suggest that the hysteresis is also temperature sensitive. At −60° C., the hysteresis is about four times than that of at −40° C. and five times than that at −20° C. For long-term cycling (FIG. 8C), a full cell at −20° C. exhibits an initial discharge capacity of 91.8 mAh g⁻¹ (−83.5% of the theoretical value) with a low decay rate (<0.055% per cycle) and a high average CE value (>98.1%) for over 100 cycles. At −40° C., the initial capacity decreases to 67.5 mAh g⁻¹ while a higher CE value (>99.6%) can be achieved. Even at −60° C., a similarly high CE (>99.5%) can still be maintained with a high capacity retention of 91.1% (a decay rate <0.089% per cycle) after 100 cycles. At −40° C. and −60° C., C-rate performance up to 1C (FIG. 8D) further confirms the superiority of Na metal batteries using the designed electrolyte at extremely cold conditions.

### Example. 1.7. Evaluation on Binary Solvent Electrolytes Based on Other Na Salts

In binary solvent electrolyte screening, most of the 0.5M NaClO₄ and NaPF₆ (as control group) based electrolytes show worse temperature-dependent behaviors compared to 0.5M NaOTf based ones. Nonetheless, 0.5M NaPF₆-DME/DOL (2:8) system exhibits comparably good performance. The high electrolyte uniformity and low electrolyte resistance increase, according to the temperature drop, is the origin of such high stability. Additionally, long-term Na/Na cycling at −80° C. further confirms the good performance. Nonetheless, DSC characterization on 0.5M NaPF₆-DME/DOL (2:8) reveals three first-order phase transitions at −96° C., −103° C. and −120° C., which possibly correspond to the mp of DOL, liquid/liquid separation and liquid/solid separation. What is more, solidification of 0.5M NaPF₆-DME/DOL (2:8) can happen when the electrolyte is stored at +20° C. The solidification/gelation process is possibly due to ring-opening polymerization, which is triggered by the binding between oxygen donor and P coordinate (NaPF₆) that is electron deficient.

As NaPF₆ salt based system presents good performance at a low temperature down to −80° C., further investigation was conducted on the binary solvent electrolytes based on the salt. In addition to DOL, another solvent candidate of tetrahydrofuran (THF) was formulated with DME and/or DEGDME due to its lower melting point of −108.4° C. After screening in a low temperature, nine out of twelve systems are stable.

Four systems including 0.5M NaPF₆-DME/DOL (2:8), 0.5M NaPF₆-DEGDME/DOL (2:8), 0.5M NaPF₆-DME/THF (2:8) and 0.5M NaPF₆-DEGDME/THF (2:8) were further evaluated in Na/Na symmetric cells. Although 0.5M NaPF₆-DME/DOL (2:8), 0.5M NaPF₆-DEGDME/DOL (2:8) and 0.5M NaPF₆-DME/THF (2:8) all show promising performance, 0.5M NaPF₆-DME/THF (2:8) is not suitable for ultra-low temperature application. It is owing to the precipitation in 0.5M NaPF₆-DME/THF (2:8) at a temperature down to −80° C. The instability at the low temperature also causes a sudden drop of the conductivity in 0.5M NaPF₆-DME/THF (2:8).

After cycling at −80° C., surface morphology of Na revealed indicates that 0.5M NaPF₆-DME/DOL (2:8) presents a smoother surface due to the good SEI formation. In addition to Na/Na symmetric cells, temperature dependent stripping/plating profiles of 0.5M NaPF₆-DME/DOL (2:8) also exhibit more stable curves and higher Coulombic efficiencies in comparison to the other two systems.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

1. An electrolyte composition comprising:
a plurality of ether-based solvents,
wherein the plurality of ether-based solvents comprise at least one acyclic ether and at least one cyclic ether; and
at least one sodium-based salt.

2. The electrolyte composition of claim 1,
wherein the at least one acyclic ether is selected from the group consisting of 1,2-dimethoxyethane (DME), diethylene glycol dimethyl ether (DEGDME), diethyl ether, methyl ethyl ether, methyl-t-butyl ether, diphenyl ether, triethylene glycol dimethyl ether, tetraethylene glycol dimethyl ether and combinations thereof, and
wherein the at least one cyclic ether is selected from the group consisting of dioxolane (DOL), tetrahydrofuran (THF), ethylene oxide, tetrahydropyran, furanand combinations thereof.

3. (canceled)

4. The electrolyte composition of claim 1, wherein the at least one acyclic ether is comprises at least one of DEGDME, DME, or combinations thereof; and wherein the at least one cyclic ether is comprises at least one of DOL, THF, or combinations thereof.

7. (canceled)

8. The electrolyte composition of claim 1, wherein the at least one sodium-based salt is selected from the group consisting of sodium trifluoromethanesulfonate (NaOTf), sodium hexafluorophosphate (NaPF₆), sodium perchlorate (NaClO₄), sodium bis(trifluoromethanesulfonyl)imide (NaTFSI), sodium bis(fluorosulfonyl)imide (NaFSI), sodium tetrafluoroborate (NaBF₄), and combinations thereof.

12. (canceled).

13. The electrolyte composition of claim 1, wherein the at least one sodium-based salt has a concentration of at least about 0.10 M.

16. (canceled).

17. The electrolyte composition of claim 1, wherein the at least one sodium-based salt has a concentration of at least about 1 M.

18-19. (canceled)

20. The electrolyte composition of claim 1, wherein the electrolyte composition is operable below −40° C.

21. The electrolyte composition of claim 1, wherein the electrolyte composition is operable below −150° C.

28. 28 (Cancelled).

29. An energy storage device comprising an electrolyte composition wherein the electrolyte composition comprises:
a plurality of ether-based solvents,
wherein the plurality of ether-based solvents comprise at least one acyclic ether and at least one cyclic ether; and
at least one sodium-based salt.

30. The energy storage device of claim 29, wherein the energy storage device is selected from the group consisting of batteries, capacitors, and combinations thereof.

31. The energy storage device of claim 29, wherein the energy storage device is a battery selected from the group consisting of sodium metal batteries, sodium ion batteries, sodium metal/ion batteries, lithium-based batteries, sodium-based batteries, lithium ion batteries, potassium-based batteries, titanium-based batteries, potassium ion based batteries, titanium-based potassium ion batteries, and combinations thereof.

32. (canceled)

33. The energy storage device of claim 29, wherein the energy storage device is a sodium-based battery.

34. The energy storage device of claim 29, wherein the energy storage device is a sodium metal battery.

35. The energy storage device of claim 29, wherein the energy storage device further comprises at least one electrode, wherein the electrode is selected from the group consisting of lithium-based electrodes, potassium-based electrodes, carbon-based electrodes, platinum-based electrodes, zinc-based electrodes, and combinations thereof.

37. 37 (Cancelled).

38. The energy storage device of claim 35, wherein the electrode comprises a sodium metal anode.

39-48. (canceled)

49. The energy storage device of claim 29,
wherein the at least one acyclic ether is selected from the group consisting of 1,2-dimethoxyethane (DME), diethylene glycol dimethyl ether (DEGDME), diethyl ether, methyl ethyl ether, methyl-t-butyl ether, diphenyl ether, triethylene glycol dimethyl ether, tetraethylene glycol dimethyl ether and combinations thereof, and
wherein the at least one cyclic ether is selected from the group consisting of dioxolane (DOL), tetrahydrofuran (THF), ethylene oxide, tetrahydropyran, furanand combinations thereof.

50. The energy storage device of claim 29, wherein the at least one sodium-based salt is selected from the group consisting of sodium trifluoromethanesulfonate (NaOTf), sodium hexafluorophosphate (NaPF₆), sodium perchlorate (NaClO₄), sodium bis(trifluoromethanesulfonyl)imide (NaTFSI), sodium bis(fluorosulfonyl)imide (NaFSI), sodium tetrafluoroborate (NaBF₄), and combinations thereof.

51. The energy storage device of claim 29, wherein the at least one sodium-based salt has a concentration of at least about 0.10 M.

52. The energy storage device of claim 29, wherein the at least one sodium-based salt has a concentration of at least about 1 M.

53. The energy storage device of claim 29, wherein the electrolyte composition is operable below −40° C.
